(19) United States
(12) Patent Application Publication
(10) Pub. No.: US 2007/0075048 A1
(43) Pub. Date: Apr. 5, 2007

(54) Welding teaching point correction system and calibration method

(75) Inventors: Akira Kunisaki, Takaoka-shi (JP); Hisanori Takata, Himi-Shi (JP)

Correspondence Address: VENABLE LLP, P.O. BOX 34385, WASHINGTON, DC, 20043-9998, US

(73) Assignee: Nachi-Fujikoshi Corp., Toyama-shi (JP)

(21) Appl. No.: 11/529,491

(22) Filed: Sep. 29, 2006

(30) Foreign Application Priority Data
Sep. 30, 2005 (JP) 2005-287467

(51) Int. Cl. B23K 11/10

(52) U.S. Cl. 219/91.1

(57) ABSTRACT

Disclosed is a welding teaching point correction system, including: a robot; a spot welding gun comprising two welding tips provided to be opposed to each other; an imaging apparatus to image a welding point of a workpiece, the imaging apparatus being provided detachably to or exchangeably with at least one of the two welding tips; an operation control unit to control the robot and the spot welding gun in accordance with an teaching program to teach welding operation to the robot and the spot welding gun; an image processing unit to acquire positional information of the welding point of the workpiece in the image; and a program correction unit to correct an teaching point for the robot in the teaching program in a plurality of directions based on the positional information of the welding point of the workpiece in the image acquired by the image processing unit.

### BACKGROUND OF THE INVENTION

1. Field of the Invention

The present invention relates to a welding teaching point correction system and a calibration method.

2. Description of Related Art

In a process such as a spot welding line of an automotive body where many spot welding robots are used, a technique of preparing an operation program of the robots beforehand has been employed for the purpose of the reduction of work man-hour and the shortening of working hours at starting up the equipment. As the method of previously preparing an operation program of a spot welding robot before the installation of the equipment, an off-line teaching system has been used, which creates a program by simulating robot operations on a computer based on the information pertaining to the mechanisms and the shapes of the robot and the spot welding gun thereof, the shape of a workpiece (material to be welded), a relative positional relation between the robot and the workpiece, necessary welding operation conditions and the like.

However, in the case where a program created by the off-line teaching system is uploaded to and used in an actual robot after the installation of the equipment, a welding position is sometimes shifted from an expected position owing to installation errors of the robot and the jig thereof, the individual difference of the robot, the dimension error of the workpiece, deflection caused by the gravity, and the like. Accordingly, it has been necessary for an operator to operate the robot by a manual operation and to ascertain the operation position of the whole or a part of welding points, so as to correct the off-line teaching data as the need arises before running automatic operation.

In order to solve such a problem, a method to correct the axial direction of a welding tip of off-line teaching data pertaining to a spot welding point has been disclosed (see, for example, JP 3191563B).

Moreover, a method to correct a shift perpendicular to the surface of a welding tip to the surface of a workpiece in off-line teaching data pertaining to a spot welding point has been disclosed (see, for example, JP 2005-138223A.

However, the disclosure of JP 3191563B has a problem that the off-line teaching data can be corrected only in data component of one direction. Moreover, because it is necessary to mark on the front-back both surfaces at a welding point of a workpiece and to install two cameras for imaging the respective marks, the disclosure of JP 3191563B has another problem that the costs of the equipment becomes high and the preparation thereof is complicated and needs a lot of trouble.

Moreover, because in the disclosure of JP 2005-138223A a camera is installed at a position different from the tip of the spot welding gun, namely, because the axis of a welding tip and the optical axis of the camera are not in agreement with each other, the disclosure of JP 2005-138223A has a problem that it is necessary to teach a robot operation for recognizing the workpiece With the camera, which takes a lot of trouble. The disclosure of JP 2005-138223A has another problem that it is apprehended that a robot body or a spot welding gun mounted on the robot interferes with the workpiece and a jig existing in the environments when the robot takes a posture of recognition with the camera. Accordingly, it is necessary to take a measure to avoid the interference, which takes a lot of trouble. The disclosure of JP 2005-138223A has a further problem that it is necessary to perform the calibration of the camera beforehand, which takes a lot of trouble, and an error caused by accuracy of the calibration easily occurs.

### SUMMARY OF THE INVENTION

The present invention was devised for settling the problems mentioned above, and it is an object of the present invention to provide a welding teaching point correction system and a calibration method, each capable of correcting an off-line teaching program of a spot welding robot simply and accurately without an operator manually correcting any welding operation positions of the off-line teaching program previously.

According to a first aspect of the invention, a welding teaching point correction system, comprises: a robot including a plurality of joints; a spot welding gun comprising two welding tips provided at a tip of the robot to be opposed to each other; an imaging apparatus to image a welding point of a workpiece by the welding tips, the imaging apparatus being provided detachably to or exchangeably with at least one of the two welding tips; an operation control unit to control the robot and the spot welding gun in accordance with an teaching program to teach welding operation to the robot and the spot welding gun; an image processing unit to perform image processing of an image imaged by the imaging apparatus, so as to acquire positional information of the welding point of the workpiece by the welding tips in the image; and a program correction unit to correct an teaching point for the robot in the teaching program in a plurality of directions based on the positional information of the welding point of the workpiece in the image acquired by the image processing of the image by the image processing unit.

To put it concretely, the imaging apparatus is freely detachably attached to at least one of the two welding tips of the spot welding gun attached at the tip of a robot so that the optical axis of the imaging apparatus may be coaxial with the axis of the welding tip, or the imaging apparatus is attached exchangeably with at least one of the two welding tips so that the optical axis of the imaging apparatus may be coaxial with the axis of the welding tip. Then, the imaging apparatus images the welding point of the workpiece. The image processing unit performs the image processing of the image imaged by the imaging apparatus to acquire the positional information of the welding point of the workpiece by the welding tip in the image. The program correction unit corrects the teaching point of the robot in the teaching program into the plurality of directions based on the positional information of the welding point of the workpiece in the image, which has been acquired by the image processing of the image.

Hereupon, because the imaging apparatus is provided so that the optical axis thereof may be coaxial with the axis of the welding tip, the operation which becomes necessary because the axis line of the welding tip and the optical axis of the camera do not agree with each other like the prior art, namely the teaching of the robot operation in order that the camera may recognize the workpiece, becomes unnecessary, and the labor necessary for off-line teaching can be reduced. Moreover, because it becomes unnecessary to perform the calibration of the imaging apparatus previously, the generation of errors caused by the calibration accuracy of the imaging apparatus can be suppressed in addition to the reduction of the labor necessary for the off-line teaching.

Moreover, because the imaging apparatus is made to be freely attachable and detachable to the one welding tip or to be interchangeable with the one welding tip, the imaging apparatus only occupies the neighborhood of the welding tip or the attachment region of the welding tip. Consequently, it is possible to decrease the possibility that the robot or the spot welding gun interferes with the workpieces or the jigs which exist in the neighborhood thereof because the posture suitable for the imaging of the welding point with the imaging apparatus is excessively pursued at the time of setting the posture for imaging the welding point with the imaging apparatus. Accordingly, it is unnecessary to take a measure to avoid such interference, and the labor necessary for the off-line teaching can be reduced.

Moreover, the program correction unit corrects the teaching point of the robot in the teaching program into the plurality of directions based on the positional information of the welding point of the workpiece in the image. Because it is thereby possible to perform the correction in the plurality of directions against the conventional correction in only one direction, the accuracy of the correction can be heightened.

According to a second aspect of the invention a welding teaching point correction system, comprises: a spot welding gun including two welding tips arranged to be opposed to each other, the spot welding gun being fixed onto a floor; a robot comprising a plurality of joints and a grasp apparatus provided at a tip of the robot to grasp a workpiece, the robot supplying the workpiece to the spot welding gun; an imaging apparatus to image a welding point of a workpiece by the welding tips, the imaging apparatus being provided detachably to or exchangeably with at least one of the two welding tips; an operation control unit to control the robot and the spot welding gun in accordance with an teaching program to teach welding operation to the robot and the spot welding gun; an image processing unit to perform image processing of an image imaged by the imaging apparatus, so as to acquire positional information of the welding point of the workpiece by the welding tips in the image; and a program correction unit to correct an teaching point for the robot in the teaching program in a plurality of directions based on the positional information of the welding point of the workpiece in the image acquired by the image processing of the image by the image processing unit.

To put it concretely, the imaging apparatus is freely detachably attached to at least one of the two welding tips of the spot welding gun fixed on the floor so that the optical axis of the imaging apparatus may be coaxial with the axis of the welding tip, or the imaging apparatus is attached exchangeably with at least one of the two welding tips so that the optical axis of the imaging apparatus may be coaxial with the axis of the welding tip. Then, the imaging apparatus images the welding point of the workpiece. The image processing unit performs the image processing of the image imaged by the imaging apparatus to acquire the positional information of the welding point of the workpiece by the welding tip in the image. The program correction unit corrects the teaching point of the robot in the teaching program into the plurality of directions based on the positional information of the welding point of the workpiece in the image, which has been acquired by the image processing of the image.

Hereupon, because the imaging apparatus is provided so that the optical axis thereof may be coaxial with the axis of the welding tip, the operation which becomes necessary because the axis line of the welding tip and the optical axis of the camera do not agree with each other like the prior art, namely the teaching of the robot operation in order that the camera may recognize the workpiece, becomes unnecessary, and the labor necessary for off-line teaching can be reduced. Moreover, because it becomes unnecessary to perform the calibration of the imaging apparatus previously, the generation of errors caused by the calibration accuracy of the imaging apparatus can be suppressed in addition to the reduction of the labor necessary for the off-line teaching.

Moreover, because the imaging apparatus is made to be freely attachable and detachable to the one welding tip or to be interchangeable with the one welding tip, the imaging apparatus only occupies the neighborhood of the welding tip or the attachment region of the welding tip. Consequently, it is possible to decrease the possibility that the robot or the spot welding gun interferes with the workpieces or the jigs which exist in the neighborhood thereof because the posture suitable for the imaging of the welding point with the imaging apparatus is excessively pursued at the time of setting the posture for imaging the welding point with the imaging apparatus. Accordingly, it is unnecessary to take a measure to avoid such interference, and the labor necessary for the off-line teaching can be reduced.

Moreover, the program correction unit corrects the teaching point of the robot in the teaching program into the plurality of directions based on the positional information of the welding point of the workpiece in the image. Because it is thereby possible to perform the correction in the plurality of directions against the conventional correction in only one direction, the accuracy of the correction can be heightened.

Preferably, one of the welding tips of the spot welding gun is fixed on an arm and the other welding tip is disposed to be opposed to and movable toward the one welding tip, and the imaging apparatus is installed to the one welding tip.

In such a case, since the imaging apparatus is installed to the one welding tip fixed on the arm, it becomes possible to reduce a probability of deviation of the optical axis caused by movement of the other welding tip.

Preferably, the program correction unit corrects the teaching point for the robot in the teaching program in a direction within a plane perpendicular to an axial direction of the welding tips on a robot tool coordinate, so that a difference in the direction within a plane perpendicular to the axial direction of the welding tips on the robot tool coordinate is a predetermined value or less based on a difference between a position of the welding point in the image imaged by the imaging apparatus and a center of an imaging area in the image when the operation control unit moves the robot so that the welding point is located on the axis of the welding tip based on the teaching program.

To put it concretely, when the robot is moved so that the welding point may be located in the neighborhood above the axis of the welding tip based on the teaching program by the operation control unit, the position of the welding point in the image imaged by the imaging apparatus and the position of the center of the imaging area in the image ought to agree with each other because the optical axis of the imaging apparatus and the axis of the welding tip are coaxial. However, both the positions do not agree with each other sometimes owing to an installation error of the robot, the machining accuracy of the robot or the spot welding gun, the deflection caused by self-weight, or the like.

In such a case, the program correction unit corrects the teaching point of the robot in the teaching program into the surface direction perpendicular to the axial direction of the welding tip in the robot tool coordinates so that the difference in the direction of the surface perpendicular to the axial direction of the welding tip in the robot tool coordinates may be the predetermined value or less based on the difference between the position of the welding point in the image imaged by the imaging apparatus and the position of the center of the imaging area.

Thereby, even if the installation error of the robot, the machining accuracy of the robot or the spot welding gun, the deflection caused by the self-weight, or the like is produced, these errors are accepted, and the program correction unit settles these errors. Consequently, the accuracy of correction can be improved.

Preferably, the welding teaching point correction system further comprises: a detection unit to detect contact of the welding tip with the workpiece when the operation control unit moves a gun opening-and-closing shaft to drive the welding tip into an axial direction or the robot in the axial direction of the welding tip, wherein the program correction unit corrects the teaching point for the robot in the teaching program in the axial direction of the welding tip on the robot tool coordinates, based on a position of the robot in the axial direction of the welding tip on the robot coordinate when the detection unit detects the contact of the welding tip to the workpiece.

To put it concretely, when the location of the welding tip to the workpiece is performed based on the teaching program by the operation control unit, the welding tip ought to abut against the workpiece by moving the gun opening-and-closing shaft or the robot in the axial direction of the welding tip in the robot tool coordinates by a prescribed distance. However, the welding tip and the workpiece do not agree with each other sometimes owing to the installation error of the robot, the machining accuracy of the robot or the spot welding gun, the deflection caused by the self-weight, or the like.

In such a case, the program correction unit corrects the teaching point of the robot in the teaching program in the axial direction of the welding tip in the robot tool coordinates based on the position of the robot in the axial direction of the welding tip in the robot tool coordinates when the detection unit has detected the contact of the welding tip with the workpiece.

Thereby, even if the installation error of the robot, the machining accuracy of the robot or the spot welding gun, the deflection caused by the self-weight, or the like is produced, these errors are accepted, and the program correction unit settles these errors. Consequently, the off-line teaching can be accurately performed.

Moreover, by combining with the correction in the surface direction perpendicular to the axial direction of the welding tip as described above, the correction in all of the directions in the three-dimensional space can be performed. Consequently, the accuracy of the correction can be heightened.

Preferably, the welding teaching point correction system further comprises: a welding point size storage unit to store a size of the welding point when the operation control unit moves the robot so that the welding point is located on the axis of the welding tip based on the teaching program, wherein the program correction unit corrects the teaching point for the robot in the teaching program in the axial direction of the welding tip on the robot tool coordinates, so that a difference between the size of the welding point in the image and the size of the welding point stored in the welding point size storage unit is a predetermined value or less based on the size of the welding point in the image imaged by the imaging apparatus and the size of the welding point stored in the welding point size storage unit when the operation control unit moves the gun opening-and-closing shaft to drive the welding tip into the axial direction or the robot in the axial direction of the welding tip on the robot tool coordinates.

To put it concretely, when the robot is moved so that the welding point may be located in the neighborhood above the axis of the welding tip based on the teaching program by the operation control unit, the size of the welding point in the image imaged by the imaging apparatus and the size of the welding point stored in the welding point size storage unit ought to agree with each other because the optical axis of the imaging apparatus and the axis of the welding tip are coaxial. However, both the sizes do not agree with each other sometimes because the distance from the welding tip to the workpiece changes owing to an installation error of the robot, the machining accuracy of the robot or the spot welding gun, the deflection caused by self-weight, or the like.

In such a case, the program correction unit corrects the teaching point of the robot in the teaching program in the axial direction of the welding tip in the robot tool coordinates so that the size of the welding point in the image may agree with the size of the welding point stored in the welding point size storage unit based on the size of the welding point in the image imaged by the imaging apparatus and the size of the welding point stored in the welding point size storage unit when the gun opening-and-closing shaft driving the welding tip in the axial direction or the robot is moved in the axial direction of the welding tip in the robot tool coordinates.

Thereby, even if the installation error of the robot, the machining accuracy of the robot or the spot welding gun, the deflection caused by the self-weight, or the like is produced, these errors are accepted, and the program correction unit settles these errors. Consequently, the accuracy of correction can be improved.

Preferably, the welding teaching point correction system further comprises: a wireless communication apparatus to connect the imaging apparatus with the image processing unit by wireless communication.

To put it concretely, the imaging apparatus and the image processing unit are wirelessly connected to each other using a wireless communication apparatus. Thereby, it is unnecessary to consider the wiring connecting the imaging apparatus and the image processing unit to each other and the restriction of the operation region which accompanies the wiring, and the degree of freedom of the arrangement of each apparatus can be heightened.

According to a third aspect of the invention, a calibration method to calibrate the imaging apparatus in correcting the teaching program using the welding teaching point correction system of the first aspect, the method comprises: a first movement step to move the robot with the operation control unit based on the teaching program so that the welding point is located on the axis of the welding tip; first imaging step to image the welding point with the imaging apparatus after moving the robot in the first movement step; second movement step to move the robot with the operation unit by a predetermined distance in a predetermined direction within a plane perpendicular to the optical axis of the imaging apparatus in robot tool coordinates; second imaging step to image the welding point with the imaging apparatus after moving the robot in the second movement step; calculation step to calculate a movement direction and a movement distance of the robot for moving the welding point in the image to a center of an imaging area based on a position of the welding point in an image imaged in the first imaging step, a position of the welding point in an image imaged in the second imaging step, a direction in and a distance by which the robot has been moved in the second movement step, a center position in the imaging area of the image; and calibration step to move the robot with the operation control unit based on the movement direction and the movement distance which have been calculated in the calculation step.

To put it concretely, when the robot is moved so that the welding point may be located in the neighborhood above the axis of the welding tip based on the teaching program in the first movement step, the position of the welding point in the image imaged by the imaging apparatus and the position of the center of the imaging area in the image ought to agree with each other in the first imaging step because the optical axis of the imaging apparatus and the axis of the welding tip are on the same axis. However, both the positions do not agree with each other sometimes owing to an installation error of the robot, the machining accuracy of the robot or the spot welding gun, the deflection caused by self-weight, or the like.

In such a case, in the second movement step, the robot is moved by the previously set distance into the direction previously set on the surface perpendicular to the optical axis of the imaging apparatus in the robot tool coordinates. Next, in the second imaging step, after moving the robot in the second movement step, the welding point is imaged with the imaging apparatus. Next, in the calculation step, the movement direction and the movement distance which are necessary for moving the welding point in the image to the center position of the imaging area are calculated based on the position of the welding point in the image imaged in the first imaging step, the position of the welding point in the image imaged in the second imaging step, the direction and the distance in which the robot has been moved in the second movement step, and the center position of the imaging area in the image. Then, in the calibration step, the calibration is performed by moving the robot based on the movement direction and the movement distance which have been calculated in the calculation step.

Thereby, even if the direction of the image and the distance from the center of the imaging area of the image to the welding point are unknown, the direction of the image and the distance of the image from the center of the imaging area to the welding point can be calculated by moving the robot in the second movement step. Consequently, the calibration can be accurately performed, and the accuracy of the correction of the teaching program can be heightened.

According to a fourth aspect of the invention, a calibration method to calibrate of the imaging apparatus in correcting the teaching program using the welding teaching point correction system according to claim 1, the method comprises: a first movement step to move the robot with the operation control unit based on the teaching program so that a specific point which locates at a predetermined distance from the welding point is located on the axis of the welding tip; a first imaging step to image the specific point with the imaging apparatus after moving the robot in the first movement step; a second movement step to move the robot with the operation unit by a predetermined distance in a predetermined direction within a plane perpendicular to the optical axis of the imaging apparatus on robot tool coordinates; a second imaging step to image the specific point with the imaging apparatus after moving the robot in the second movement step; a calculation step to calculate a movement direction and a movement distance of the robot for moving the specific point in the image to a center of an imaging area based on a position of the specific point in an image imaged in the first imaging step, a position of the specific point in an image imaged in the second imaging step, a direction in and a distance by which the robot has been moved in the second movement step, a center position in the imaging area of the image; and a calibration step to move the robot with the operation control unit based on the movement direction and the movement distance which have been calculated in the calculation step.

To put it concretely, when the robot is moved so that the specific point may be located in the neighborhood above the axis of the welding tip based on the teaching program in the first movement step, the position of the specific point in the image imaged by the imaging apparatus and the position of the center of the imaging area in the image ought to agree with each other in the first imaging step because the optical axis of the imaging apparatus and the axis of the welding tip are coaxial. However, both the positions do not agree with each other sometimes owing to an installation error of the robot, the machining accuracy of the robot or the spot welding gun, the deflection caused by self-weight, or the like.

In such a case, in the second movement step, the robot is moved by the previously set distance into the direction previously set on the surface perpendicular to the optical axis of the imaging apparatus in the robot tool coordinates. Next, in the second imaging step, after moving the robot in the second movement step, the specific point is imaged with the imaging apparatus. Next, in the calculation step, the movement direction and the movement distance which are necessary for moving the specific point in the image to the center position of the imaging area are calculated based on the position of the specific point in the image imaged in the first imaging step, the position of the specific point in the image imaged in the second imaging step, the direction in and the distance by which the robot has been moved in the second movement step, and the center position of the imaging area in the image. Then, in the calibration step, the calibration is performed by moving the robot based on the movement direction and the movement distance which have been calculated in the calculation step.

Thereby, even if the direction of the image and the distance from the center of the imaging area of the image to the specific point are unknown, the direction of the image and the distance from the center of the imaging area of the image to the specific point can be calculated by moving the robot in the second movement step. Consequently, the calibration can be accurately performed, and the accuracy of the correction of the teaching program can be heightened.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a schematic configuration view of a welding teaching point correction system;

FIG. 2 is a front view of a spot welding gun;

FIG. 3 is a front view of the spot welding gun;

FIG. 4 is a block diagram showing the configuration of the welding teaching point correction system;

FIG. 5 is a block diagram showing the function of the welding teaching point correction system;

FIG. 6 is a flowchart showing the XY direction correction processing of an teaching point determined by an teaching program;

FIG. 7 is an explanatory view of an XY direction correction method of the teaching point determined by the teaching program;

FIG. 8 is a flowchart showing the Z direction correction processing of the teaching point determined by the teaching program;

FIG. 9 is an explanatory view of the Z direction correction method of the teaching point determined by the teaching program;

FIG. 10 is a flowchart showing calibration processing; and

FIGS. 11A and 11B are explanatory views of a calibration method.

### DETAILED DESCRIPTION OF THE PREFERRED EMBODIMENTS

In the following, the best embodiment of a welding teaching point correction system and a calibration method are described in detail with reference to the attached drawings. In addition, the direction perpendicular to the axial direction of a welding tip is supposed to an X direction, the direction perpendicular to the axial direction of the welding tip and perpendicular to the X direction is supposed to a Y direction, and the direction along the axial direction of the welding tip is supposed to a Z direction at the time of the correction of an welding teaching point.

<Configuration of Welding Teaching Point Correction System>

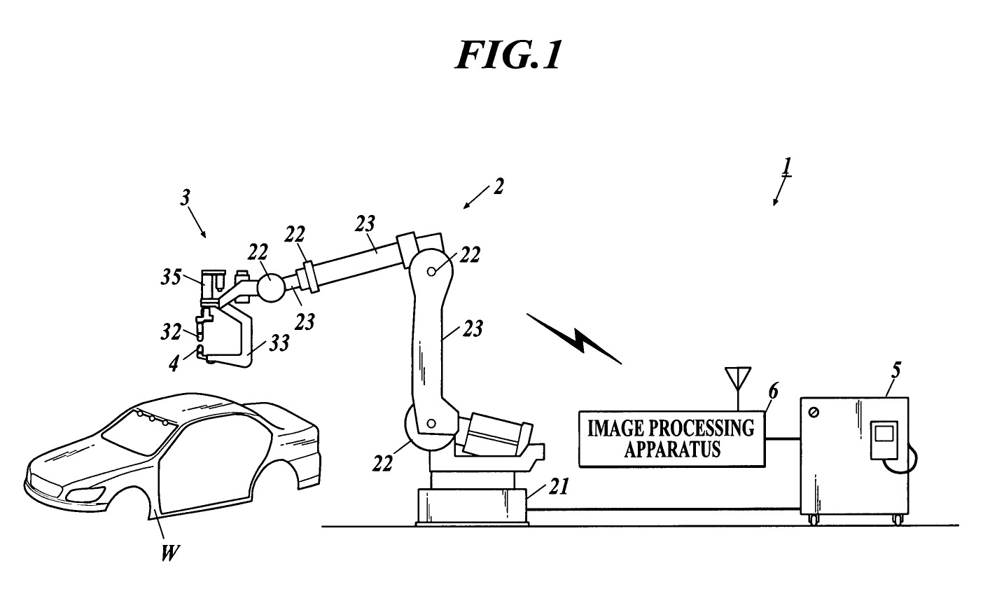

As shown in FIG. 1, a welding teaching point correction system 1 is equipped with a multi-axis robot 2 having a plurality of joints and arms, a spot welding gun 3 provided at the tip of the robot 2, a camera 4 as an imaging apparatus to image a welding point of a workpiece W to which spot welding is performed by the spot welding gun 3, a control apparatus 5 to perform the operation control of the robot 2, the spot welding gun 3 and the camera 4, and an image processing apparatus 6 to perform the image processing of an image imaged by the camera 4.

(Robot)

As shown in FIG. 1, the robot 2 is used at a spot welding line of the body frame of an automobile, for example. The robot 2 is equipped with a base 21 used as a foundation, a plurality of arms 23 coupled with each other with joints 22, and a servomotor (not shown) to drive the robot 2. The spot welding gun 3 is provided at one end of the coupled arms 23.

Each of the joints 22 consists of either one of a swing joint in which one end pivotally supports the other end of an arm 23, and the rotation joint which supports the axis of an arm 23 itself rotatably around the lengthwise direction of the arm 23. That is, the robot 2 is equivalent to the so-called articulated robot.

(Spot Welding Gun)

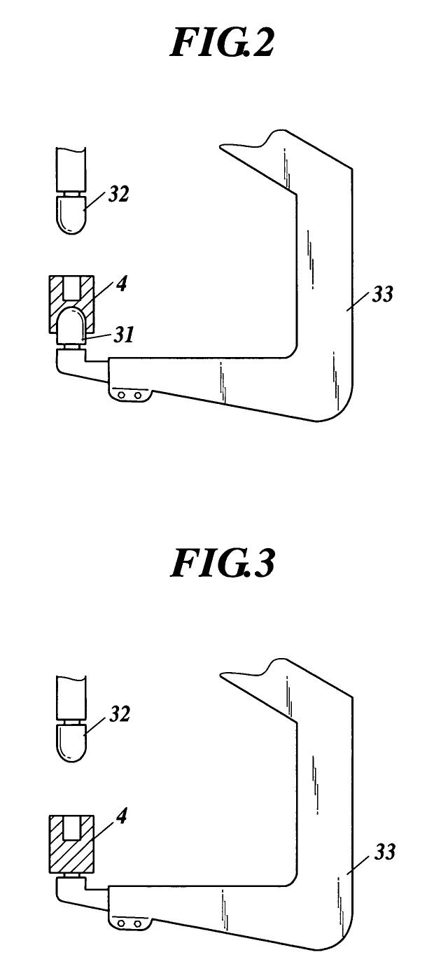

As shown in FIGS. 1 and 2, the spot welding gun 3 has two welding tips (electrodes) 31 and 32. One welding tip 31 is fixed to an arm 33. The other welding tip 32 is driven toward the welding tip 31 on the other side along with the gun opening-and-closing shaft 35 by being driven by the gun opening-and-closing shaft 35 with a servomotor (not shown). The welding tips 31 and 32 are arranged so as to be opposed to each other. That is, the workpiece W can be nipped with the welding tips 31 and 32 by driving the gun opening-and-closing shaft 35 with the servomotor to be narrowing the interval between the welding tips 31 and 32. Then, spot welding can be performed by electrifying each of the welding tips 31 and 32 in the state of nipping the workpiece W between the welding tips 31 and 32. In addition, the drive control of the servomotor is carried out by a control signal from the control apparatus 5.

(Camera)

As shown in FIG. 2, for example, a small-sized CCD camera is used as the camera 4. The camera 4 is provided to at least one welding tip 31 between the two welding tips 31 and 32 in the state of being freely attachable to and detachable from the welding tip 31. In this case, the camera 4 is provided so that the optical axis thereof may be coaxial with the axis of the welding tip 31. Although the camera 4 may be provided to either of the two welding tips 31 and 32, it is preferable to provide the camera 4 to the welding tip 31 fixed to the arm 33. This is for decreasing the occurrence probability of the shifts of the optical axis by the movements of the welding tip 32.

In addition, as shown in FIG. 3, at least one welding tip 31 may be removed from the arm 33, and the camera 4 may be provided at the removed position. In other words, the welding tip 31 and the camera 4 may be exchangeably provided to the arm 33. In the present embodiment, descriptions are given to an example in which the welding tip 31 is exchanged with the camera 4.

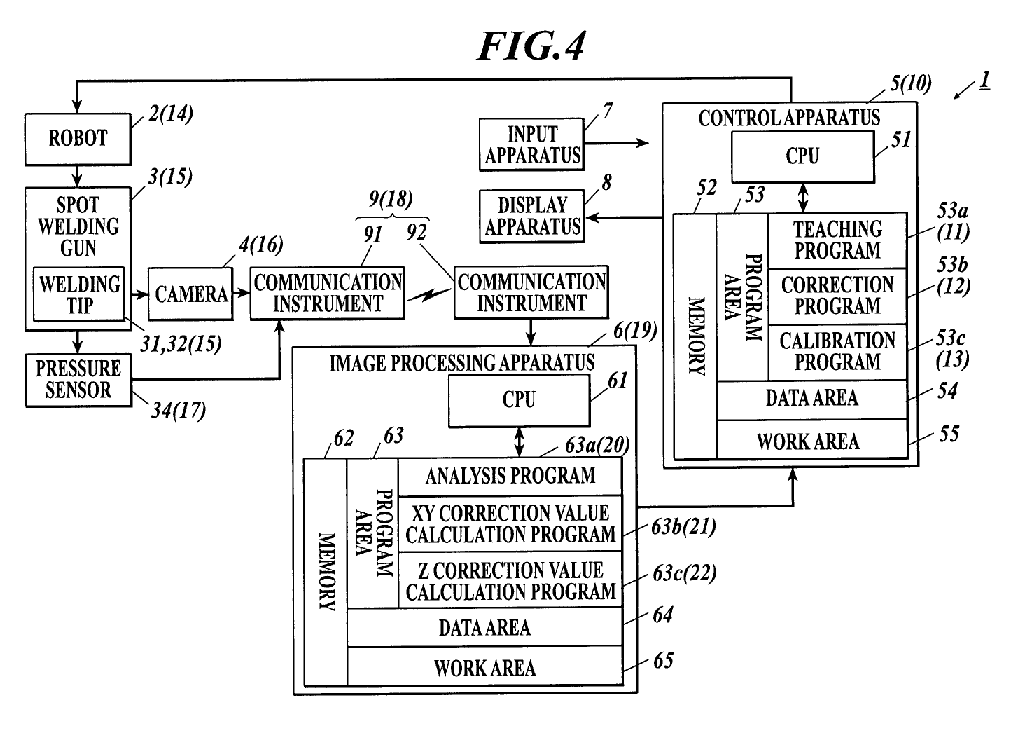

Moreover, as shown in FIG. 4, the camera 4 is provided with a communication instrument 91, which is connected with the image processing apparatus 6 by wireless communications to constitute a wireless communication apparatus 9. The communication instrument 91 transmits image data imaged by the camera 4 to a communication instrument 92 in order to carry out image processing in the image processing apparatus 6.

In addition, it is desirable to use a camera having a characteristic of a wide focus range (a deep focal depth) as the camera 4 to be used in order to recognize a welding point surely even when an error arises in the distance between the workpiece W and the camera 4.

(Control Apparatus)

As shown in FIG. 4, the control apparatus 5 is equipped with a CPU 51 which performs each processing according to a processing program about the operation control of the robot 2 and the like, and a memory 52 to store the processing program, processing data and the like for performing each processing.

In the memory 52, a program area 53 to store the processing program to drive the robot 2 and the like, a data area 54 to store the data necessary for the drive control of the robot 2, a work area 55 where various work memories, counters and the like are provided and each processing is performed are formed.

The program area 53 stores an teaching program 53a to realize the function of teaching a welding operation to the robot 2 and the spot welding gun 3 to perform their operation control.

The program area 53 stores a correction program 53b to realize the function of correcting the teaching point of the robot 2 in the teaching program 53a into a plurality of directions based on the positional information of a welding point of a workpiece W in an image acquired by the image processing of the image transmitted from the image processing apparatus 6. That is, the control apparatus 5 receives the correction values of a plurality of positional components for correcting the teaching program 53a to store the received correction values into the data area 54. Then, the control apparatus 5 reads the correction values from the data area 54 to correct the teaching program 53a at the time of the execution of the correction program 53b.

The program area 53 stores a calibration program 53c to correct the difference between the position of the robot 2 (the position of the robot in the camera coordinates) in the image imaged by the camera 4 and the actual position of the robot 2 (the position of the robot 2 in the robot tool coordinates).

The control apparatus 5 is provided with an input apparatus 7, to which an operation teaching from a user is input, and a display apparatus 8 to display the information to be informed to the user such as an image by the camera 4.

In addition, the input apparatus 7 and the display apparatus 8 may be provided in the main body of the control apparatus 5, or may be provided on a pendant connected to the main body of the control apparatus 5 with a wire or wirelessly for realizing remote control.

(Image Processing Apparatus)

As shown in FIG. 4, the image processing apparatus 6 is equipped with a CPU 61 to execute each processing according to an image processing program of an image imaged with the camera 4, and a memory 62 to store a processing program to execute each processing, processing data and the like.

A program area 63 to store the image processing program of an image and the like, a data area 64 to store the data necessary for image processing, and a work area 65 where various work memories, counters and the like are provided and each processing is performed are formed in the memory 62.

The program area 63 stores an analysis program 63a to realize the function of performing the image processing of an image imaged with the camera 4 to acquire the positional information of a welding point of a workpiece by the welding tips 31 and 32 in the image.

The program area 63 stores an XY correction value calculation program 63b to calculate a correction value to correct the positional components in the X direction and the Y direction when the control apparatus 5 corrects the teaching program 53a.

The program area 63 stores a Z correction value calculation program 63c for calculating the correction value to correct the positional component in the Z direction when the control apparatus 5 corrects the teaching program 53a.

The image processing apparatus 6 is provided with the communication instrument 92 connected with the camera 4 by wireless communications to constitute the wireless communication apparatus 9. The communication instrument 92 receives the image data imaged by the camera 4 from the communication instrument 91 in order to make the image processing apparatus 6 perform the image processing.

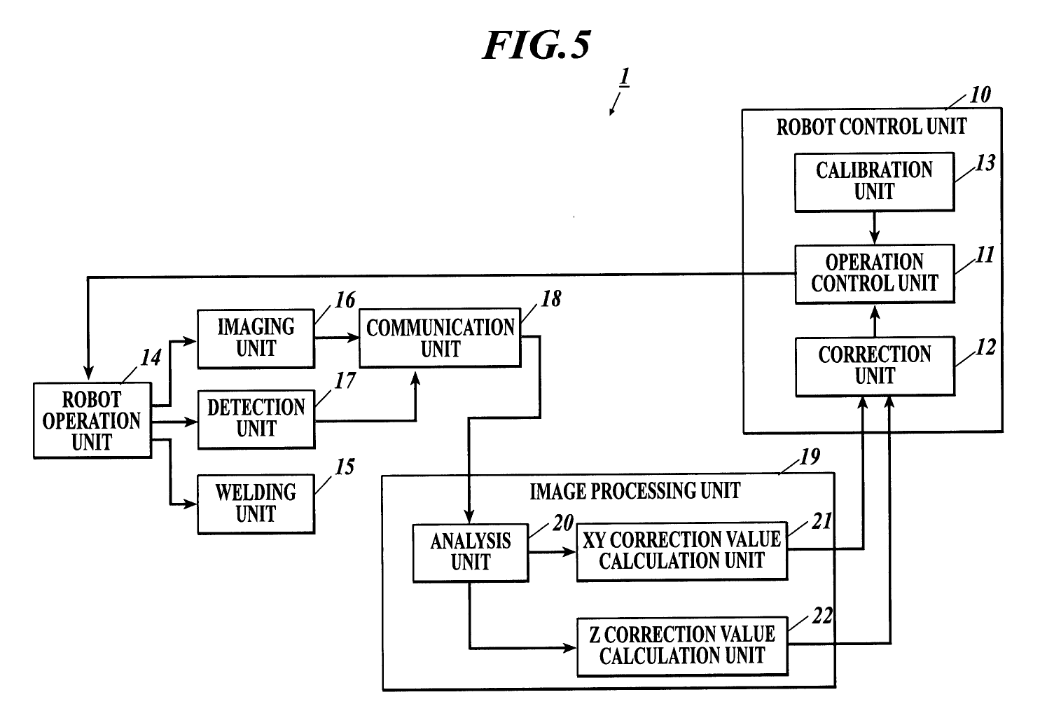

FIG. 5 is a block diagram showing the functions of the welding teaching point correction system 1.

The welding teaching point correction system 1 includes a robot control unit 10 to perform the operation control of the robot 2. The function of the robot control unit 10 is borne by the control apparatus 5.

The robot control unit 10 includes an operation control unit 11 to transmit an operation signal to the robot 2 to perform the operation control of the robot 2, the spot welding gun 3 and the like by the CPU 51's execution of the teaching program 53a. The operation control unit 11 functions as an operation control unit.

The robot control unit 10 includes a correction unit 12 to correct the teaching program 53a based on a correction value received from the image processing apparatus 6 by the CPU 51's execution of the correction program 53b. The correction unit 12 functions as a program correction unit.

The robot control unit 10 includes a calibration unit 13 to correct a difference between the position of the robot 2 in the camera coordinates and the position of the robot 2 in the robot tool coordinates by the CPU 51's execution of the calibration program 53c.

The welding teaching point correction system 1 includes a robot operation unit 14 to operate based on a control signal from the robot control unit 10. The function of the robot operation unit 14 is borne by the drive units of the robot 2 such as the arms 23 and the like.

The welding teaching point correction system 1 includes a welding unit 15 to be driven by the operation of the robot operation unit 14 to perform spot welding of the workpiece W. The function of the welding unit 15 is borne by the spot welding gun 3 equipped with the two welding tips 31 and 32.

The welding teaching point correction system 1 includes an imaging unit 16 to image a welding point of a workpiece W by the welding tips 31 and 32. The function of the imaging unit 16 is borne by the camera 4.

The welding teaching point correction system 1 includes a detection unit 17 to detect the contact of the welding tip 32 with the workpiece W. The function of the detection unit 17 is borne by a pressure sensor 34 provided in the welding tip 32. In addition, it is only the time of correcting the teaching program 53a that the pressure sensor 34 is provided in the welding tip 32, and an actual welding is performed by exchanging the pressure sensor 34 with the normal welding tip 32 when the welding is actually performed. That is, the pressure sensor 34 is used at the time of correcting the position in the Z direction. Moreover, the detected signal detected by the pressure sensor 34 is wirelessly transmitted to the image processing apparatus 6 through the communication instrument 91 and the communication instrument 92.

The welding teaching point correction system 1 includes a communication unit 18 to wirelessly connect the imaging unit 16 or the detection unit 17 with an image processing unit 19. The function of the communication unit 18 is borne by the wireless communication apparatus 9.

The welding teaching point correction system 1 includes the image processing unit 19 to perform the image processing of an image imaged by the imaging unit 16. The function of the image processing unit 19 is borne by the image processing apparatus 6.

The image processing unit 19 includes an analysis unit 20 to perform the image processing of the image imaged by the imaging unit 16 to analyze the positional information of a welding point of the workpiece W by the welding tip 31 and 32 in the image. The analysis unit functions as the image processing unit.

The image processing unit 19 includes an XY correction value calculation unit 21 to correct an teaching point of the robot 2 in the teaching program 53a into the X direction and the Y direction in the robot tool coordinates so that the difference in the surface direction perpendicular to the axial direction of the welding tips 31 and 32 in the robot tool coordinates may be a predetermined value or less based on the difference between the position of a welding point of an image imaged by the camera 4 and the position of the center of the imaging area in the image when the robot operation unit 14 is moved so that the welding point may be located in the neighborhood above the axis of the welding tips 31 and 32 by the operation control unit 11 based on the teaching program 53a by the CPU 61's execution of the XY correction value calculation program 63b. The XY correction value calculation part 21 functions as the program correction unit. Hereupon, being the predetermined value or less ideally means that the difference in the surface direction perpendicular to the axial direction of the welding tips 31 and 32 in the robot coordinates becomes zero.

The image processing unit 19 includes a Z correction value calculation unit 22 to correct the teaching point of the robot 2 in the teaching program 53a into the axial direction of the welding tip 32 in the robot tool coordinates based on the position of the robot 2 in the axial direction of the welding tip 32 in the robot tool coordinates when the pressure sensor 34 as the detection unit to detect the contact of the welding tip 32 to the workpiece W by the contact to the workpiece W has detected the contact of the welding tip 32 to the workpiece W by the CPU 61's execution of the Z correction value calculation program 63c. The Z correction value calculation unit 22 functions as the program correction unit.

<Correction Processing of Teaching Point by Welding Teaching Point Correction System>

The correction processing of the teaching point by the welding teaching point correction system is described by dividing the correction processing into the corrections in the X direction and the Y direction and the correction in the Z direction.

(Corrections of X Direction and Y Direction)

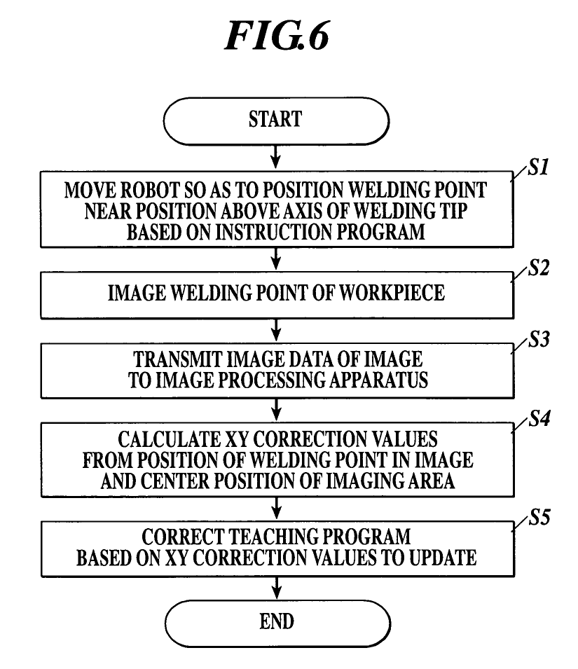

As shown in FIG. 6, the robot 2 is moved so that a welding point of a workpiece W may be located in the neighborhood above the axis of the welding tip 32 by the execution of the teaching program 53a by the CPU 51 of the control apparatus 5 (Step S1).

Next, the CPU 51 sends an imaging teaching signal to the camera 4, and makes the camera 4 image the welding point of the workpiece W (Step S2).

Then, the CPU 51 wirelessly transmits the image data of the image to the communication instrument 92 through the communication instrument 91. The communication instrument 92, which has received the image data of the image, transmits the image data to the image processing apparatus 6 (Step S3).

Next, the CPU 61 of the image processing apparatus 6 executes the analysis program 63a to perform the image processing of the image data, and analyses the positional information of the welding point of the workpiece W in the image. The CPU 61 then executes the XY correction value calculation program 63b to calculate the XY correction values from the positional information of the welding point of the workpiece W in the image and the positional information of the center position of the imaging area (Step S4), and transmits the calculated XY correction values to the control apparatus 5.

Next, the CPU 51 executes the correction program 53b to correct the teaching program 53a based on the calculated XY correction values, and updates the corrected teaching program 53a to a corrected program (Step S5). Then, the CPU 51 ends the present processing at this time.

Here, an instantiation is given to describe the correction processing in the X direction and in the Y direction.

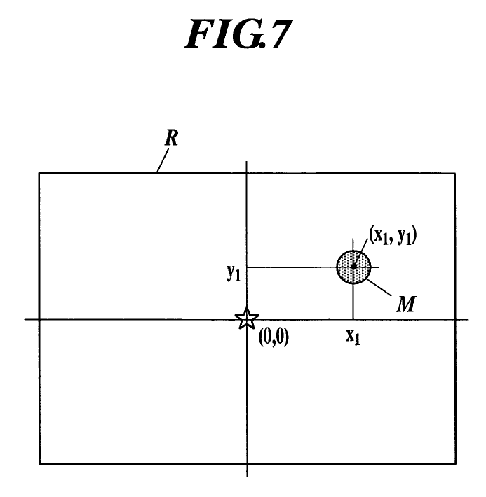

It is supposed that the image is one shown in FIG. 7 when the robot 2 is moved so that the welding point of the workpiece W may be located in the neighborhood above the axis of the welding tip 32 and a welding point M is imaged with the camera 4.

In such a state, by executing the analysis program 63a, the CPU 61 acquires the center position coordinates (0, 0) of an imaging area R, and the center position coordinates (x1, y1) of the welding point M. By executing the XY correction value calculation program 63b, the CPU 61 calculates the correction value of the teaching program 53a so that the center position coordinates of the welding point M may come to the center position coordinates (0, 0) of the imaging area R in the image. In this case, because both the position coordinates agree with each other by moving the center position coordinates of the welding point M by −x1 in the X directions and by −y1 in the Y direction, these correction values are transmitted to the control apparatus 5. Then, by executing the correction program 53b, the CPU 51 of the control apparatus 5 adds −x1 in the X direction and −y1 in the Y direction to the position coordinate data in the teaching program 53a to correct the teaching program 53a.

(Correction of Z Direction)

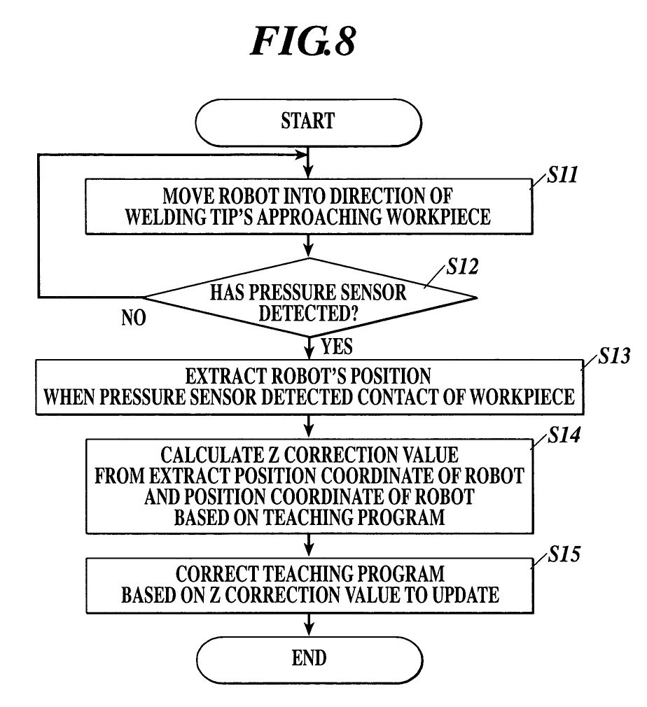

As shown in FIG. 8, by executing the teaching program 53a, the CPU 51 of the control apparatus 5 moves the robot 2 so that the welding tip 32 may approach the workpiece W (Step S11).

Next, the CPU 61 of the image processing apparatus 6 judges whether CPU 61 has received the detected signal indicating that the pressure sensor 34 has detected the contact with the workpiece W or not (Step S12). Here, when the CPU 61 judges that the CPU 61 has received the detected signal indicating that the pressure sensor 34 has contacted the workpiece W (Step S12: YES), the CPU 61 extracts the position of the robot at the time when the pressure sensor 34 has contacted the workpiece W (Step S13).

Next, by executing the Z correction value calculation program 63c, the CPU 61 calculates a Z correction value from the position coordinates of the robot 2 which has been extracted at Step S13, and the position coordinates of the robot 2 based on the teaching program 53a (Step S14), and transmits the calculated Z correction value to the control apparatus 5.

Next, by executing the correction program 53b, the CPU 51 of the control apparatus 5 corrects the teaching program 53a based on the calculated Z correction value to update the teaching program 53a to a corrected program (Step S15), and terminates the present processing at this time.

Here, the Z direction correction processing is described by citing an instantiation.

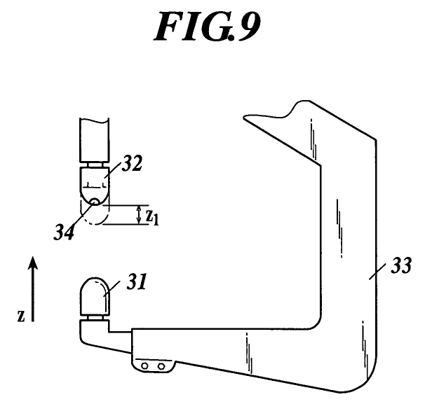

It is supposed that the robot 2 is moved so that the welding tip 32 may approach the workpiece W and the position of the robot 2 when the pressure sensor 34 has contacted the workpiece W is one expressed by the solid line in FIG. 9.

In such a state, it is supposed that the position of the robot 2 based on the teaching program 53a is a position of the chain line in FIG. 9, the CPU 61 executes the Z correction value calculation program 63c to calculate a difference z1 in the Z direction of both the positions. In this case, because both the position coordinates agree with each other by moving the robot 2 in the Z direction by −z1, the correction value is transmitted to the control apparatus 5. Then, by executing the correction program 53b, the CPU 51 of the control apparatus 5 performs the addition of −z1 in the Z direction to the position coordinate data in the teaching program 53a to correct the teaching program 53a.

<X-Y Correction Value Calculation Process>

A description is given to a process to calculate a X-Y correction value from positional information of the welding point and positional information of the center point of the imaging area in an image imaged by the camera.

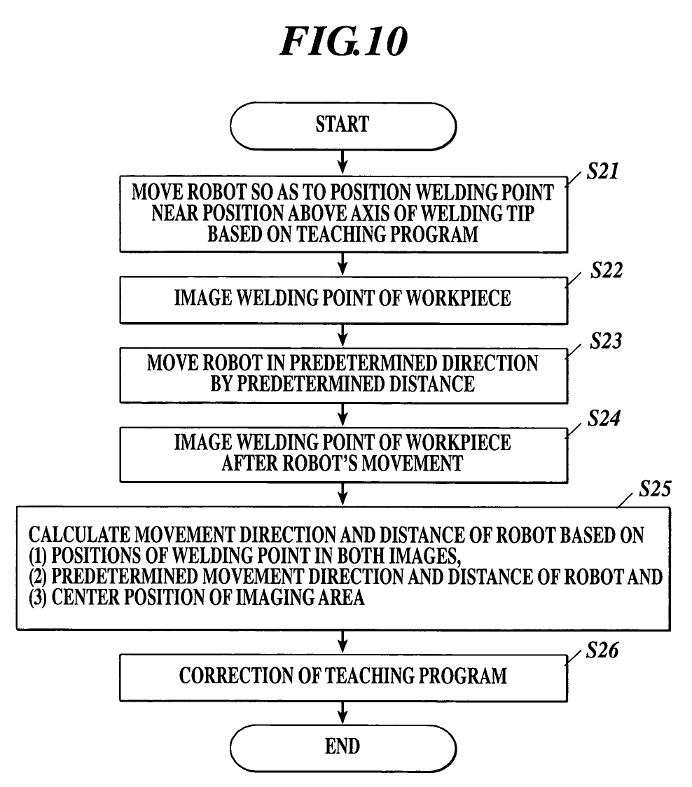

As shown in FIG. 10, when the X-Y correction value calculation process is started after attaching the camera 4 at an arm 33, the CPU 51 of the control apparatus 5 moves the robot 2 in accordance with the teaching program 53a so that the welding point is located in the neighborhood above the axis of the welding tip 32 (Step S21: first movement process).

Next, the CPU 51 requests the image processing apparatus 6 to perform imaging, so as to make the camera 4 image the welding point (Step S22: first imaging process).

Next, the CPU 51 moves the robot 2 in a direction set in the calibration program 53c beforehand on the XY plane by the previously set distance (Step S23: second movement process).

Next, the CPU 51 requests the image processing apparatus 6 to perform imaging, so as to make the camera 4 image the welding point after the movement of the robot 2 (Step S24: second imaging process).

Next, the CPU 51 calculates the movement direction and the movement distance of the robot 2, i.e. the X-Y correction value, which are necessary for moving the welding point in the image to the center position of the imaging area, based on the position of the welding point in the image imaged in Step S22, the position of the welding point in the image imaged in Step S24, the direction and the distance in which the robot 2 has been moved in Step S23, and the center position of the imaging area in the image (Step S25: calculation process).

Next, the CPU 51 corrects the teaching program 53a based on the X-Y correction value which have been calculated in Step S25 (Step S26: teaching program correction process).

Here, a description is given to the X-Y correction value calculation process by citing an instantiation.

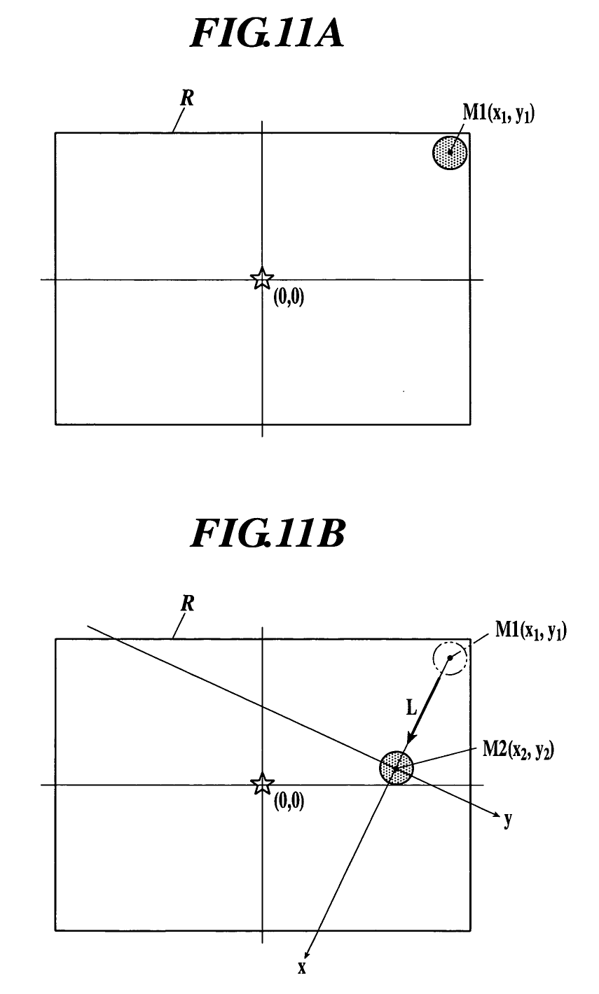

It is supposed that the robot 2 is moved so that the welding point of the workpiece W may be located in the neighborhood above the axis of the welding tip 32 and an image when the welding point M1 is imaged by the camera 4 is in the state shown in FIG. 11A. In such a state, the CPU 51 moves the robot 2 into the direction by the distance which has been beforehand set by the calibration program 53c. Here, it is supposed that the state has changed to the one shown in FIG. 11B when the robot 2 has been moved in the X direction by a distance L on the robot tool coordinates.

In this case, because the robot 2 has been moved only in the X direction, it is found that the direction of a line connecting the welding point M1 and the welding point M2 with a straight line corresponds to the movement on the robot tool coordinates. Moreover, it is also found that the direction perpendicular to the X direction is the Y direction. It is assumed that the Y direction is a direction of the X axis rotated by −90° on the image.

Furthermore, if it is supposed that the XY position coordinates of the welding point M1 are (x1, y1) and the XY position coordinates of the welding point M2 are (x2, y2), the vectors in the X direction and the Y direction of the robot tool coordinates in the camera coordinates are expressed as follows.

$${v}_{x} = ( \begin{matrix}{x}_{2} - {x}_{1} \\ {y}_{2} - {y}_{1}\end{matrix} ) \qquad {v}_{y} = ( \begin{matrix}{y}_{2} - {y}_{1} \\ - ( {x}_{2} - {x}_{1} )\end{matrix} )$$

If the center coordinates of the imaging area R are set to (0, 0) based on the formula, the X correction value Lx and Y correction value Ly of the robot 2 can be calculated by the following formulae.

$${L}_{x} = L \cdot \frac{- {x}_{2} \cdot ( {x}_{2} - {x}_{1} ) - {y}_{2} \cdot ( {y}_{2} - {y}_{1} )}{{( {x}_{2} - {x}_{1} )}^{2} + {( {y}_{2} - {y}_{1} )}^{2}}$$

$${L}_{y} = L \cdot \frac{- {x}_{2} \cdot ( {y}_{2} - {y}_{1} ) - {y}_{2} \cdot ( {x}_{2} - {x}_{1} )}{{( {x}_{2} - {x}_{1} )}^{2} + {( {y}_{2} - {y}_{1} )}^{2}}$$

The CPU 51 corrects the teaching program 53a based on the correction values Lx and Ly calculated in accordance with these formulae.

<Operation and Effects>

According to the embodiment mentioned above, the camera 4 is attached in place of the welding tip 31 on one side of both of the two welding tips 31 and 32 of the spot welding gun 3 provided at the tip of the robot 2 so that the optical axis may be coaxial with the axis of the welding tip 32. Then, the camera 4 images the welding point of the workpiece W of the welding tip 32. The image processing apparatus 6 performs the image processing of the image imaged by the camera 4 to acquire the positional information of the welding point of the workpiece W by the welding tip 32 in the image. Then, the control apparatus 5 corrects the teaching point of the robot 2 in the teaching program 53a into a plurality of directions based on the positional information of the welding point of the workpiece W in the image acquired by the image processing of the image.

Here, because the camera 4 is provided so that the optical axis thereof may be coaxial with the axis of the welding tip 32, the operation which becomes necessary owing to the disagreement of the axis line of the welding tip 32 with the optical axis of the camera 4 like in the prior art, i.e. the teaching of the robot operation to recognize the workpiece W with the camera 4, becomes unnecessary, and consequently the labor necessary for off-line teaching can be reduced. Moreover, because it becomes unnecessary to perform the calibration of the camera 4 beforehand, the labor necessary for the off-line teaching can be reduced, and also the generation of the error resulting from the calibration accuracy of the camera 4 can be suppressed.

Moreover, because camera 4 is made to be exchangeable with the welding tip 31 on one side, the camera 4 only occupies the attachment region of the welding tip 31. The possibility that the robot 2 or the spot welding gun 3 interferes with the workpiece and jig which exist in the neighborhood thereof just because the posture of the camera 4 which is suitable for the imaging of the welding point with the camera 4 is pursued too much when the camera 4 takes a posture for imaging the welding point can be decreased. Consequently, it is not necessary to take any measures for avoiding such interference, and the labor necessary for the off-line teaching can be reduced.

Moreover, because the ascertainment operation which has been performed by an operator so far can be automatized, labor costs can be reduced and equipment preparation costs lowered.

Moreover, the dispersion of the operation qualities by operators is eliminated to enable the creation of the stable and accurate teaching program 53a.

Furthermore, in the case of a welding line using many robots, because the program ascertain and correction operations of a plurality of robots can be simultaneously performed, the operations can be completed in a short time, and an equipment starting preparation period can be shortened.

Moreover, the control apparatus 5 corrects the teaching point of the robot 2 in the teaching program 53a into the XY plane direction in the robot tool coordinates so that the difference in the XY plane direction in the robot tool coordinates may be a predetermined value (e.g. the difference is zero) or less based on the difference between the position of the welding point in the image imaged by the camera 4 and the position of the center of the imaging area in the image.

Moreover, the control apparatus 5 corrects the teaching point of the robot 2 in the teaching program 53a into the Z direction in the robot tool coordinates based on the position of the robot 2 in the Z direction in the robot tool coordinates when the pressure sensor 34 has detected the contact of the welding tip 32 to the workpiece W.

Thereby, even if an installation error of the robot 2, the machining accuracy of the spot welding gun 3, the deflection caused by self-weight, and the like are generated, these errors are accepted and are settled by the correction program 53b. Consequently, the accuracy of the correction can be raised.

Moreover, because the corrections in all the directions (the X, the Y and the Z directions) in a three-dimensional space can be performed, the accuracy of the corrections can be raised.

Moreover, by wirelessly connecting the camera 4 with the image processing apparatus 6 using the wireless communication apparatus 9, it is unnecessary to take into consideration the wiring connecting the camera 4 with the image processing apparatus 6, the restriction of the operation region accompanying the wiring, and the like. Consequently, the degree of freedom of the arrangement of each apparatus can be raised.

Moreover, when the robot 2 is moved so that the welding point may be located in the neighborhood above the axis of the welding tip 32 based on the teaching program 53a, the position of the welding point M1 in the image imaged by the camera 4 and the position of the center of the imaging area in the image ought to be in agreement with each other because the optical axis of the camera 4 and the axis of the welding tip 32 are coaxial. However, both the positions do not sometimes agree with each other owing to the installation error of the robot 2, the machining accuracy of the robot 2 or the spot welding gun 3, the deflection caused by self-weight, and the like.

In such a case, the robot 2 is moved in a previously set direction on the XY plane in the robot tool coordinates by a previously set distance. Next, after the movement of the robot 2, the welding point M2 is imaged by the camera 4. Next, the movement direction and the movement distance of the robot 2 necessary for moving the welding point M2 in the image to the center position of the imaging area R based on the positions of both the imaged welding point M1 and M2, the direction and the distance of the movement of the robot 2, and the center position of the imaging area R in the image. Then, the teaching program of the robot 2 is corrected based on the movement direction and the movement direction.

Thereby, even if the direction of the image and the distance from the center of the imaging area R of the image to the welding point are unknown, the direction of the image and the distance from the center of the imaging area R of the image to the welding point M2 can be calculated by moving the robot 2. Consequently, the correction can be accurately performed, and the accuracy of the correction can be raised.

<Others>

In addition, the present invention is not restricted to the above-mentioned embodiment. For example, when the correction of the teaching program 53a is performed using the calculated correction value, the correction may be performed as follows. The robot 2 is moved to the position acquired by adding the calculated correction value, and error is measured again to ascertain the error is within a predetermined accuracy range. When the error is out of the range, the measurement and the correction may be repeated until the error falls in the predetermined accuracy range. Moreover, the size of the welding point may be previously stored in the data area 54 (welding point size storage unit) of the control apparatus 5. When the gun opening-and-closing shaft 35 or the robot 2 is moved in the Z direction in the robot tool coordinates, the teaching point of the robot 2 in the teaching program 53a may be corrected in the Z direction so that the difference between the size of the welding point in the image and the size of the welding point stored in the data area 54 may be a predetermined value (e.g. both the sizes may agree with each other) or less based on the difference and ratio between the size of the welding point in the image and the size of the welding point stored in the data area 54.

Thereby, even if the installation error of the robot 2, the machining accuracy of the robot 2 and the spot welding gun 3, the deflection caused by self-weight, and the like are generated, these errors are accepted, and these errors are corrected. Consequently, the accuracy of the correction can be raised.

Moreover, although the necessary movement quantity of the robot 2 is calculated by acquiring the positional difference between the position of the welding point, which is set as a reference, to the workpiece by the welding tip 32 and the position of the robot 2 in calculating the correction value of the teaching program, the correction of the teaching program may be performed using a specific point located at a position distant from the welding point by a predetermined distance as a reference. In addition, the distance from the welding point can be arbitrarily set, namely, it can be said that any position of the workpiece may be the specifying point. In a word, what is necessary is that the correction of the teaching program is performed using some position as the reference.

Moreover, as for the welding method using a robot also, the spot welding gun 3 may be fixed on a floor, and a robot provided with a grasp apparatus to grasp a workpiece at the tip of the robot may be moved toward the spot welding gun 3.

Moreover, the programs stored in the program area 53 may be ones broken down more finely, or all the programs may be integrally configured.

Moreover, although the processing pertaining to the correction of the teaching program 53a is performed by software, the correction may be configured to be performed using hardware.

Moreover, although the C type spot welding gun is used as the welding gun, an X type spot welding gun may be used.

Moreover, the method of detecting the contact of the welding tip 32 with the workpiece W is not limited to used the pressure sensor 34, but, for example, a method of detecting the contact of he welding tip 32 to the workpiece W by electrifying a weak current to welding tip 32 always, and by detecting a change of a current value or a voltage value when the welding tip 32 contacts to the workpiece W to detect the contact.

Moreover, although the camera 4 and the image processing apparatus 6 are separately configured in the embodiment mentioned above, it is possible to perform the processing of an image using the camera 4 to transmit the image data wirelessly to the control apparatus 5 by using a camera equipped with an image processing function as the camera 4.

Moreover, although the control apparatus 5 and the image processing apparatus 6 are separately configured, it is possible to perform the image processing with the control apparatus 5 to control the robot 2 based on the data of the image processing by wirelessly transmitting the image imaged by the camera 4 when the control apparatus 5 is equipped with an image processing function. These configurations can be freely changed based on a demand of an operator or a designer.

In addition, the design of the embodiment can be freely changed within the essential scope of the present invention.

The entire disclosure of Japanese Patent Application No. 2005-287467 filed on Sep. 30, 2006, including description, claims, drawings and summary are incorporated herein by reference.

What is claimed is:

1. A welding teaching point correction system, comprising:
a robot including a plurality of joints;
a spot welding gun comprising two welding tips provided at a tip of the robot to be opposed to each other;
an imaging apparatus to image a welding point of a workpiece by the welding tips, the imaging apparatus being provided detachably to or exchangeably with at least one of the two welding tips;
an operation control unit to control the robot and the spot welding gun in accordance with an teaching program to teach welding operation to the robot and the spot welding gun;
an image processing unit to perform image processing of an image imaged by the imaging apparatus, so as to acquire positional information of the welding point of the workpiece by the welding tips in the image; and
a program correction unit to correct an teaching point for the robot in the teaching program in a plurality of directions based on the positional information of the welding point of the workpiece in the image acquired by the image processing of the image by the image processing unit.

2. A welding teaching point correction system, comprising:
a spot welding gun including two welding tips arranged to be opposed to each other, the spot welding gun being fixed onto a floor;
a robot comprising a plurality of joints and a grasp apparatus provided at a tip of the robot to grasp a workpiece, the robot supplying the workpiece to the spot welding gun;
an imaging apparatus to image a welding point of a workpiece by the welding tips, the imaging apparatus being provided detachably to or exchangeably with at least one of the two welding tips;
an operation control unit to control the robot and the spot welding gun in accordance with an teaching program to teach welding operation to the robot and the spot welding gun;
an image processing unit to perform image processing of an image imaged by the imaging apparatus, so as to acquire positional information of the welding point of the workpiece by the welding tips in the image; and
a program correction unit to correct an teaching point for the robot in the teaching program in a plurality of directions based on the positional information of the welding point of the workpiece in the image acquired by the image processing of the image by the image processing unit.

3. The welding teaching point correction system according to claim 1,
wherein one of the welding tips of the spot welding gun is fixed on an arm and the other welding tip is disposed to be opposed to and movable toward the one welding tip, and
the imaging apparatus is installed to the one welding tip.

4. The welding teaching point correction system according to claim 1, wherein the program correction unit corrects the teaching point for the robot in the teaching program in a direction within a plane perpendicular to an axial direction of the welding tips on a robot tool coordinate, so that a difference in the direction within a plane perpendicular to the axial direction of the welding tips on the robot tool coordinate is a predetermined value or less based on a difference between a position of the welding point in the image imaged by the imaging apparatus and a center of an imaging area in the image when the operation control unit moves the robot so that the welding point is located on the axis of the welding tip based on the teaching program.

5. The welding teaching point correction system according to claim 4, further comprising:
a detection unit to detect contact of the welding tip with the workpiece when the operation control unit moves a gun opening-and-closing shaft to drive the welding tip into an axial direction or the robot in the axial direction of the welding tip,
wherein the program correction unit corrects the teaching point for the robot in the teaching program in the axial direction of the welding tip on the robot tool coordinates, based on a position of the robot in the axial direction of the welding tip on the robot coordinate when the detection unit detects the contact of the welding tip to the workpiece.

6. The welding teaching point correction system according to claim 4, further comprising:
a welding point size storage unit to store a size of the welding point when the operation control unit moves the robot so that the welding point is located on the axis of the welding tip based on the teaching program,
wherein the program correction unit corrects the teaching point for the robot in the teaching program in the axial direction of the welding tip on the robot tool coordinates, so that a difference between the size of the welding point in the image and the size of the welding point stored in the welding point size storage unit is a predetermined value or less based on the size of the welding point in the image imaged by the imaging apparatus and the size of the welding point stored in the welding point size storage unit when the operation control unit moves the gun opening-and-closing shaft to drive the welding tip into the axial direction or the robot in the axial direction of the welding tip on the robot tool coordinates.

7. The welding teaching point correction system according to claim 1, further comprising: a wireless communication apparatus to connect the imaging apparatus with the image processing unit by wireless communication.

8. A calibration method to calibrate the imaging apparatus in correcting the teaching program using the welding teaching point correction system according to claim 1, the method comprising:
a first movement step to move the robot with the operation control unit based on the teaching program so that the welding point is located on the axis of the welding tip;
a first imaging step to image the welding point with the imaging apparatus after moving the robot in the first movement step;
a second movement step to move the robot with the operation unit by a predetermined distance in a predetermined direction within a plane perpendicular to the optical axis of the imaging apparatus in robot tool coordinates;
a second imaging step to image the welding point with the imaging apparatus after moving the robot in the second movement step;
a calculation step to calculate a movement direction and a movement distance of the robot for moving the welding point in the image to a center of an imaging area based on a position of the welding point in an image imaged in the first imaging step, a position of the welding point in an image imaged in the second imaging step, a direction in and a distance by which the robot has been moved in the second movement step, a center position in the imaging area of the image; and
a calibration step to move the robot with the operation control unit based on the movement direction and the movement distance which have been calculated in the calculation step.

9. A calibration method to calibrate of the imaging apparatus in correcting the teaching program using the welding teaching point correction system according to claim 1, the method comprising:
a first movement step to move the robot with the operation control unit based on the teaching program so that a specific point which locates at a predetermined distance from the welding point is located on the axis of the welding tip;
a first imaging step to image the specific point with the imaging apparatus after moving the robot in the first movement step;
a second movement step to move the robot with the operation unit by a predetermined distance in a predetermined direction within a plane perpendicular to the optical axis of the imaging apparatus on robot tool coordinates;
a second imaging step to image the specific point with the imaging apparatus after moving the robot in the second movement step;
a calculation step to calculate a movement direction and a movement distance of the robot for moving the specific point in the image to a center of an imaging area based on a position of the specific point in an image imaged in the first imaging step, a position of the specific point in an image imaged in the second imaging step, a direction in and a distance by which the robot has been moved in the second movement step, a center position in the imaging area of the image; and
a calibration step to move the robot with the operation control unit based on the movement direction and the movement distance which have been calculated in the calculation step.
